(19) United States
(12) Patent Application Publication
(10) Pub. No.: US 2018/0044576 A1
(43) Pub. Date: Feb. 15, 2018

(54) STABILIZED PILLARS FOR HYDRAULIC FRACTURING FIELD OF THE DISCLOSURE

(71) Applicant: Schlumberger Technology Corporation, Sugar Land, TX (US)

(72) Inventors: Danil Sergeevich PANTSURKIN, Novosibirsk (RU); Geza HORVATH SZABO, Sugar Land, TX (US); Mohan Kanaka Raju PANGA, Katy, TX (US)

(21) Appl. No.: 15/555,689

(22) PCT Filed: Mar. 3, 2015
(86) PCT No.: PCT/RU2015/000129

§ 371 Date: Sep. 5, 2017

(51) Int. Cl. C09K 8/80; E21B 43/267

(52) U.S. Cl. CPC C09K 8/805; C09K 8/80; E21B 43/267; C09K 2208/08

(57) ABSTRACT

Methods of strengthening a proppant pack and resulting proppant pillar from both the inside and outside are described. Embodiments various additives to facilitate proppant/proppant interaction and modifying proppant surface to facilitate proppant interaction. Embodiments also include the use of protective coatings, some of which have embedded fibers or chemical moieties to divert flow from pillar.

### FIELD OF THE DISCLOSURE

The disclosure generally relates to methods, materials and systems for hydraulic fracturing of reservoirs to increase production therefrom.

BACKGROUND OF THE DISCLOSURE

Some fractures form naturally—certain veins or dikes are examples. Induced hydraulic fracturing (also hydrofracturing or “fracking”) is a well stimulation technique in which a high-pressure fluid is injected into a wellbore in order to create fractures (typical dimension of 5.0 mm wide) in the deep-rock formations in order to allow natural gas, petroleum, brine, and other fluids to migrate to the well.

In order to keep the fractures open even after the pressure is reduced, small grains of hard material called “proppants” are co-injected into the well. The proppants (typically sand or ceramic materials) hold open the small fractures once the deep rock achieves geologic equilibrium. Herein, this type of the treatment is referred to as “conventional” fracturing treatment and the type proppant pack placed is referred to as a “homogeneous” proppant pack.

FIG. 1 displays a schematic of a hydraulic fracturing process. A pressurized mixture is injected into a well and the pressure inside the well causes the reservoir rock to crack. The mixture can also flow from the well into the cracks to propagate the fractures. Recovered fracturing fluid and released hydrocarbons can then be produced, separated, and processed.

Although each oil and gas zone is different and requires a hydraulic fracturing design tailored to the particular conditions of the formation, a fracturing job often has 4 stages:

1. An acid stage, consisting of several thousand gallons of water mixed with a dilute acid such as hydrochloric or muriatic acid. This serves to clear any debris or damage in the perforations of the wellbore and provide an open conduit for other fracturing fluids by dissolving carbonate minerals and opening fractures near the wellbore.

2. A pad stage, consisting of approximately 100,000 gallons of slickwater, linear gel, or crosslinked gel without proppant material: The pad stage fills the wellbore and opens the formation and helps to facilitate the flow and placement of proppant material.

3. A prop sequence stage, which may consist of several substages of water, linear or crosslinked gel combined with proppant material. This stage may collectively use several hundred thousand gallons of water. Proppant material may vary from a finer particle size to a coarser particle size throughout this sequence.

4. A flushing stage, consisting of a volume of fresh water sufficient to flush the excess proppant from the wellbore. At this point, depending on the well, hydrocarbons can be collected.

Some embodiments of a fracturing fluid should:

Be able to transport the propping agent in the fracture

Be compatible with the formation rock and fluid

Generate enough pressure drop along the fracture to create a wide fracture

Minimize friction pressure losses during injection

Use chemical additives that are approved by environmental regulations

Exhibit controlled-break to a low-viscosity fluid for cleanup after the treatment

Be cost-effective

Water-based fracturing fluids have become the predominant type of coalbed methane fracturing fluid. However, fracturing fluids can also be based on oil, methanol, or a combination of water and methanol. Methanol is used in lieu of, or in conjunction with, water to enhance fluid recovery.

In some cases, nitrogen or carbon dioxide gas is combined with the fracturing fluids to form foam as the base fluid. Foams require substantially lower volumes to transport an equivalent amount of proppant. Diesel fuel is another component of some fracturing fluids, although it is not used as an additive in all hydraulic fracturing operations. It often works as a fluid loss control additive.

A variety of other fluid additives (in addition to the proppants) may be included in the fracturing fluid mixture to perform essential tasks such as formation clean up, foam stabilization, leakoff inhibition, or surface or interfacial tension reduction. These additives include biocides, fluid-loss agents, enzyme breakers, acid breakers, oxidizing breakers, friction reducers, and surfactants, such as emulsifiers and non-emulsifiers. Several products may exist in each of these categories. On any one fracturing job, different fluids may be used in combination or alone at different stages in the fracturing process. Engineers will often devise the most effective fracturing scheme, based on formation characteristics, using the fracturing fluid combination they deem most effective.

The viscosity of the fracturing fluid is a point of differentiation in both the execution and in the expected fracture geometry. “Slickwater” treatments use low-viscosity fluids pumped at high rates to generate narrow, complex fractures with low-concentrations of propping agent (0.2-5 lb proppant added (PPA) per gallon). In order to minimize risk of premature screenout, pumping rates must be sufficiently high to transport proppant over long distances (often along horizontal weilbores) before entering the fracture. By comparison, for conventional wide-biwing fractures the carrier fluid must be sufficiently viscous (normally 50 to 1000 cp at nominal shear rates from 40-100 sec⁻¹) to transport higher proppant concentrations (1-10 PPA per gallon). These treatments are often pumped at lower pump rates and may create wider fractures (normally 0.2 to 1.0 inch).

The density of the carrier-fluid is also important. The fluid density affects the surface injection pressure and the ability of the fluid to flow back after the treatment. Water-based fluids generally have densities near 8.4 ppg. Oil-base fluid densities will be 70 to 80% of the densities of water-based fluids, and foam-fluid densities can be substantially less than those of water-based fluids. In low-pressure reservoirs, low-density fluids, like foam, can be used to assist in the fluid cleanup. Conversely, in certain deep reservoirs (including offshore frac-pack applications), there is a need for higher density fracturing fluids whose densities can span up to >16 ppg.

Heterogeneous proppant placement or “HPP” is a service for hydraulic fracturing, for sale for commercial scale operations by Schlumberger Technology Corporation U.S. Pat. No. 6,776,235 provides general details and is incorporated by reference herein. HPP includes sequentially injecting into the wellbore alternate stages of fracturing fluids having a contrast in their ability to transport propping agents to improve proppant placement or having a contrast in the amount of transported propping agents. The propped fractures obtained have a pattern characterized by a series of bundles of proppant spread along the fracture. In other words, the bundles form “pillars” that keep the fracture open along its length and provide channels for the formation fluids to circulate.

What are needed are yet further methods and materials for use for HPP.

### SUMMARY OF THE DISCLOSURE

This application discloses methods for hydraulic fracturing a subterranean formation that enhance hydraulic fracture conductivity by forming stronger proppant clusters using methods with approaches for pillar composition, chemical, and design variations.

US20120125618 et seq discloses methods for hydraulic fracturing of subterranean formation having a first pad stage comprising injection of fracturing fluid into a borehole, the fluid containing thickeners to create a fracture in the formation; and a second stage comprising introduction of proppant into the injected fracturing fluid to prevent closure of the created fracture, and further, comprising introducing a fiber into the fracturing fluid to provide formation of proppant clusters in the created fracture and channels for flowing formation fluids. The fibers are capable of decomposing in the water-based fracturing fluid or in the downhole fluid, such as fibers made on the basis of e.g., polylactic acid, polyglycolic acid, polyethylene terephthalate (PET), polyvinylalcohol, and their copolymers and the like.

This disclosure, in contrast, relates to longer lasting reinforcing agents. The pillar enforcement can be effective during flow-back, hydrocarbon production, and/or injection. Proppant flow-back is a leading cause of well production decline, equipment damage, and shut-ins for repair. Some of the embodiments disclosed not only strengthen the pillar but also allow for re-positioning of the proppant pack without losing pack integrity.

One embodiment increases proppant pack strength by using pillar stabilizing additives in the proppant carrier fluid. For instance, additives such as non-degradable fibers (NDF) can be added to the proppant carrier fluid and, when settling in a fracture, can form a network of physical chains that interweave throughout and/or around the proppant pack and subsequent pillar. The network reinforces the pillar and provides structure for proppants to settle on or attach thereto.

Other additives can be used to fill the void space between proppants to increase contact between proppants, between proppants and reservoir rock, and/or between proppants and fibers. These void space fillers can be particles, grains, fibers, and the like and can be altered to improve interactions between proppants and others components. Another benefit of filling the void space is the effective sealing of the pack structure by removing pockets of proppant carrier fluid that can be washed out.

In some embodiments, these additives are introduced at the same time the proppant and proppant carrier is combined. However, introduction of the additives in a separate plug or alternating injections with the proppant is possible. The non-degradable fibers and void fillers can be coated or have other surface treatment to improve adhesion with other additives, the proppants, or the reservoir rock.

The fibers and void fillers can also have a degradable coating to prevent interaction during injection. Thus, the coating can degrade under reservoir conditions (e.g., be heat degradable or hydrocarbon soluble) allowing the fibers to form the desired network only after reaching deep into the reservoir.

The NDF can also have shape memory properties. The fibers can be injected in a deformed shape, then, upon application of some environmental factor such as heat, pH, fluid composition change, or pressure etc., the fibers can return to their original shape. Thus, the NDF can be injected as e.g. compact balls or twist, and return to a straighter shape in the reservoir or vice versa. “Straight” fibers can be injected and made to shrink downhole to help consolidate the pillar. This effect can be gained not only due to shape memory, but also because of irreversible material structure change.

Other changes can be an increase in fiber volume when exposed to higher temperatures, or exposure of solvent or reactive moieties on the fiber as it unravels. Exemplary materials of such swellable fibers include composite fibers such as a PLA (or resin, PUR, glass etc.) matrix with embedded swellable filler (e.g. superabsorbent, clay). Although the PLA matrix can degrade, the filler typically stays in place. Such composite fibers can also be coated to delay in swelling. Other suitable polymers that swell on contact with water are polyacrylic acids, described in U.S. Pat. No. 3,066,118 or U.S. Pat. No. 3,426,004, or copolymers of ethylene and maleic anhydride disclosed in U.S. Pat. No. 3,951,926. All three patents are incorporated by reference herein.

Examples of pH controlled swelling include chemically cross-linked poly(aspartic acid) (PASP), chemically cross-linked poly(N-vinylimidazole) (PVI), Polyanion/gelatin complexes including poly(methacrylic acid) (PMAA)/gelatin, poly(acrylic acid) (PAA)/gelatin, and heparin/gelatin. Additionally, any polyelectrolyte can undergo electrolyte-controlled swelling in salt containing aqueous media when the concentration of the salt is decreased.

In another aspect, the proppant pillar or pack has a protective outer layer to help strengthen the pillar from the outside. Requirements for such a layer are: long-term ability to withstand the fluid flow and its reactivity (or the ability of the layer to reheal itself under the production conditions), strong affinity to proppant pack and ability to coat the proppant pack without risk of reservoir impairment.

The protective layer can be applied during later stages of treatment, after the initial propping stage, or during proppant injection. For instance, the coating substance can be encapsulated and added to the proppant pack. Thus, once a pillar is formed and the proppant carrier fluid is removed, the coating substance can be released upon dissolution of the encapsulating material or formation stress or can diffuse through encapsulating material. This release can be delayed if a later coating is desired.

In one embodiment, encapsulated and uncured resins are placed simultaneously with the proppant placement. The resin-curing material can be placed in different capsules and co-injected or injected sequentially with the proppant. The capsules containing resin and the capsules containing a curing additive can contain filler additives too, which do not necessarily participate in the resin-curing procedure but may strengthen the integrity of the pack or pillar.

In some embodiments, the uncured resin comprises at least one resin selected from the group consisting of a two-component epoxy-based resin, a furan-based resin, a phenolic-based resin, a high-temperature epoxy-based resin, a phenol/phenol formaldehyde/furfuryl alcohol resin, acrylic based resin, and a combination thereof. The curing additive comprises at least one initiator selected from the group consisting of: benzoyl peroxide, 2,2′-azo-bis-isobutyrylnitrile, or a combination thereof. When the resin is a two-component resin, each of these components should be encapsulated separately. Alternatively, the resin-curing materials can be injected as a liquid additive, which is either dissolved in the fracturing fluid or added to the fluid in the form of emulsion. In this latter case the resin-curing material reacts with the resin released from the capsules either at the boundary of the pillar or within the pillar. Thermosetting resins can also be used without the need for a curing additive.

In yet another aspect, the proppant particle itself can be modified to enhance proppant/proppant, proppant/reservoir, and proppant/additive interactions to enhance pillar strength. For instance, the surface of the proppant can be modified or coated to enhance chemical bonding, mechanical bonding, friction/cohesion or wettability. US20050244641, incorporated herein by reference, describes methods of applying hydrophobic coatings to the proppant surface prior to injection. In a single proppant injection, proppants having a variety of surface characteristics can be used.

Finally, a combination of proppants with differing properties can be used in the proppant pack. Proppants such as “soft” mineral substances (e.g. talc, mica, calcium carbonate, sodium chloride (NaCl)) can be additives to the proppant pack. The ideal “soft” mineral material has a hardness smaller than that of proppant and is inert to the frac/injection/production fluid to survive for a long enough time. A sand and NaCl mixture is more stable than a pure sand pack under the same fluid flow conditions.

Proppants having elastic character can also be used in the proppant pack in addition to more traditional proppants. To achieve this elastic character, particles can be made of polymers, metals or other compounds having a sufficient Poisson's ratio. This allows the particle to change shape and adapt to the bottom hole conditions as well as adapt to the stress within the pillar. For example, an elastic proppant may change shape and flatten out when squished by e.g. reservoir rock. Though flattening is usually not desired, there is a trade-off between losing some pillar conductivity and having a lower rate of pillar erosion. Though the fracture width may be small, the flattened proppant can still be in contact with other proppants, thus enlarging the proppant contact under applied stress conditions.

Particulates having elastic character comprises only a fraction of the injected proppant. Thus, the traditional proppant could hold the stress, while the elastic particulates fill up some of the pore-space between the proppant. This space-filling serves multiple objectives: (i) provides better distribution of the stress between proppant-proppant and proppant-rock, which lead to higher stress tolerance of the pillar; and (ii) increases the stickiness between the grains and between the grains and the rock, which could stabilize proppant arches. Stable proppant arches reduce pillar spreading under stress and reduce pillar erosion tendency as well. Additionally, by filling the void space in the proppant pack, the flattened elastic proppants are reinforcing the pack, much like a cement.

If the elastic proppant is flattened too much and channels are closed, more proppant can be injected or some sand/ceramics can be added to the pack to reduce the extent of squashing. Adding sand/ceramics to the proppant pack will also set minimum pack thickness (depending on sand/ceramic proppant content and properties).

Embodiments of the above aspects, either separate or combined, will increase conductivity in the fracture. Interconnected networks and void space fillers allow for strong pillars without residual viscous gels that hinder produced fluid flow. Coatings divert fluid flow from the proppant pack thus preventing wash out or fingering. Furthermore, these improvements maintain the integrity of the pack such that it can be settled and re-settled in a fracture using clean fluids.

Embodiments herein are directed generally to a proppant slurry, having a plurality of proppant particles in a base fluid, the slurry injected so as to form proppant pillars in a fracture of a reservoir in order to prop open fractures, wherein added to the improved slurry is a pillar stabilizing additive including one or more of the following in any combination thereof: non-degradable fibers; void space fillers; a second fluid resistant to flow and more dense than a base fluid; semi-rigid fibers for coating the proppant pillars with a first layer having the semi-rigid fibers partially embedded therein to divert flow of a fluid from the proppant pillars; a coating material for coating the pillars and diverting flow therearound, wherein the coating material can be a hydrophilic material; a hydrophobic material; a low friction material; a soft material; a thermosetting material; a curable material; or an adhesive material, and such coating materials can themselves be encapsulated or coated to delay activation. Proppant slurries, proppant pillars and proppant packs containing the pillar stabilizing materials are also provided.

Another embodiment is a proppant pack, including a plurality of proppant particles in the form of proppant pillars in a fracture of a reservoir, the proppant pillar propping open the fractures, the improvement comprising having non-degradable fibers (NDF) in or around the proppant pillars., The proppant pack can include sand, light weight proppant, intermediate strength proppant or high strength proppant (HSP) and 0.1-5% NDF or 0.5-1.5%.

Another embodiment is a proppant pack, including a plurality of proppant particles forming proppant pillars in a fracture of a reservoir, the proppant pillar propping open the fractures, and adding any of the pillar stabilizing materials described herein to the proppant pack.

Methods of enhancing conductivity of a fracture in a subterranean reservoir are also provided, using the proppant slurries and pack herein described.

In more detail, the methods of treating or fracturing a subterranean formation include a) providing a treatment fluid comprising a base fluid, proppant particulates, plus any of the additives described herein, wherein the additive is either co-injected with base fluid and proppant particulates or injected thereafter; b) injecting the treatment fluid into fractures in a reservoir; and c) producing hydrocarbons through the fractures. As is known the art, the base fluids and proppant slurry injections can be varied to optimize pillar placement and size.

The terms “proppant” and “particulate” are used interchangeably to refer to a pulverized or particulate solid suitable for use in subterranean operations. Suitable solids include, but are not limited to, sand; bauxite; ceramic materials; glass materials; polymer materials; Teflon® materials; nut shell pieces; seed shell pieces; cured resinous particulates comprising nut shell pieces; cured resinous particulates comprising seed shell pieces; fruit pit pieces; cured resinous particulates comprising fruit pit pieces; wood; composite particulates; and combinations thereof.

Composite particulates may also be suitable, suitable composite materials may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof. The resulting proppant pack can be either homogeneous or heterogeneous, as desired.

Fiber includes any material or physical body in which the length ratio between any one of the three spatial dimensions exceeds that of either one, or both of the other two dimensions, by a factor of at least 5:1, or at least 10:1, or at least 50:1. This means a body aspect ratio of greater than 5:1, or 10:1, or 50:1. A fiber may include a ribbon or plate.

Non-degradable herein relates to the stability of a material, which is assessed by introducing non-degradable material proppant pillars and measuring stability. The stability should be at least 1.5 fold (50% higher) higher over the same proppants without the non-degradable material, and preferably at least 2 fold, 5 fold, or 10 fold. The non-degradable fibers (NDFs) tested and described below exhibited more than 10 fold stability increase under the experimental conditions tested.

Proppant slurry includes a fluid mixture having solid particulates with a liquid, such as proppant plus water or base fluid. A slurry is often mixed with base fluid to make the final proppant fluid. Alternatively, proppant can be mixed directly into the base fluid, without being made into a slurry first, depending on the equipment.

Proppant pack includes a collection of proppant particulates within a fracture propping the fracture open so that fluids may flow therefrom. Proppant slurry additives and carrier fluid may partially remain in the proppant pack after placement.

Proppant pillar includes a group or collection of proppant particles that form a coherent body when placed in a fracture or distinct region with higher density of particles than the surrounding region, often in a substantially pillar-like structure or placement. The open space between proppant pillars may form a network of interconnected open channels, available for the flow of fluids into the wellbore. This results in an increase of the effective hydraulic conductivity and porosity of the overall fracture.

Pillar stabilizing material includes any of the NDFs, void space fillers, coating agents, and the like, which increase the stability of the pillar against typical reservoir fluid flow, such that the proppant pillar has a longer lifespan under typical flow conditions such as exposure to downhole conditions. Stabilization can be measured by the methods disclosed herein, or other suitable flow experiments, and should be at least a 25% increase in stability against flow, preferably 50%-100% or more. Two fold, three fold, five fold, ten fold and higher increases in lifespan of the pillar may occur in some embodiments.

Proppant coating or coating material includes a phase that is immiscible with the fracturing fluid and produced fluid and would not readily peel-off, dissolve, or otherwise degrade from the surface of the proppant or pillar (under reservoir conditions as well as during fracturing operation) once the proppant or pillar is coated.

Void space filler includes a solid or semisolid particle that is not the same material as the proppant particles, and that fills a part of the space between pillars and/or proppant particles. The concentration of total void space filler in some embodiments is 0.1 to 20 percent by weight of the proppant pack.

Soft or semi-rigid materials include material which has viscoelastic behavior and/or high yield stress and is not miscible with the fracturing fluid. The elastic features should be in the range which would ensure stress bearing properties under reservoir conditions. The time relaxation of the elastic components should be long enough to ensure for at least 1 year stress-bearing. Additionally, soft or semi-rigid materials have a lower hardness than other proppants.

Proppant carrier or base fluid includes any thick and/or dense fluid that carries the proppant under the conditions of use. Proppant carriers include gels, foams, viscoelastic surfactants, emulsions, micelles, and the like, that carry the proppant into the fractures. See Table 1 for representative base fluids and their uses.

TABLE 1
FRACTURING FLUIDS AND CONDITIONS FOR THEIR USE

| Base | | | |
|---|---|---|---|
| Fluid | Fluid Type | Main Composition | Used For |
| Water | Linear | Guar, HPG, HEC, | Short fractures, low |
| | | CMHPG | temperature |
| | Crosslinked | Crosslinked + Guar, | Long fractures, high |
| | | HPG, CMHPG or | temperature |
| | | CMHEC | |
| | Micellar | Electrolyte + | Moderate length fractures, |
| | | Surfactant | moderate temperature |
| Foam | Water based | Foamer + N₂ or CO₂ | Low-pressure formations |
| | Acid based | Foamer + N₂ | Low pressure, carbonate |
| | | | formations |
| | Alcohol | Methanol + | Low-pressure, water-sensitive |
| | based | Foamer + N₂ | formations |
| Oil | Linear | Gelling agent | Short fractures, water sensitive |
| | | | formations |
| | Crosslinked | Gelling agent + | Long fractures, water-sensitive |
| | | Crosslinker | formations |
| | Water | Water + Oil + | Moderate length fractures, |
| | emulsion | Emulsifier | good fluid loss control |
| Acid | Linear | Guar or HPG | Short fractures, carbonate |
| | | | formations |
| | Crosslinked | Crosslinker + Guar | Longer, wider fractures, |
| | | or HPG | carbonate formations |
| | Oil emulsion | Acid + Oil + | Moderate length fractures, |
| | | Emulsifier | carbonate formations |

Further, for simplicity of description, only simple fracturing fluids are described, but, of course, any of the usual additives can be included therein, such as anti-corrosive agents, anti-scaling agents, friction reducers, acids, salts, anti-bacterial agents, wetting agents, buffers, and the like. Representative additives are shown in Table 2. These can be added to a fluid at any point during mixing, injection, or downhole, depending on well conditions.

TABLE 2
SUMMARY OF CHEMICAL ADDITIVES

| Type of Additive | Function Performed | Typical Products |
|---|---|---|
| Biocide | Kills bacteria | Glutaraldehyde carbonate |
| Breaker | Reduces fluid viscosity | Acid, oxidizer, enzyme breaker |
| Buffer | Controls the pH | Sodium bicarbonate, fumaric |
| | | acid |
| Clay stabilizer | Prevents clay swelling | KCl, NH₄Cl, KCl substitutes |
| Diverting agent | Diverts flow of fluid | Ball sealers, rock salt, flake |
| | | boric acid |
| Fluid loss | Improves fluid | Diesel, particulates, fine sand |
| additive | efficiently | |
| Friction reducer | Reduces the friction | Anionic copolymer |
| Iron Controller | Keeps iron in solution | Acetic and citric acid |
| Surfactant | Lowers surface tension | Fluorocarbon, Nonionic |
| Gel stabilizer | Reduces thermal | MeOH, sodium thiosulphate |
| | degradation | |

### BRIEF DESCRIPTION OF THE DRAWINGS

FIG. 1. (prior art) is a schematic showing a typical hydraulic fracturing procedure.

FIG. 2A-B. (prior art) are proppant distribution following a waterfrac treatment using a homogenous proppant pack.

FIG. 3A-B. (prior art) are proppant distribution as a result of alternating proppant-fluid stage to provide a heterogenous proppant pack.

FIG. 4 are pictures of proppant pack after exposure to fluid flow for 2 hours: a) 0 weight percent NDF; b) 0.7 weight percent NDF; c) 1.4 weight percent NDF. The NFD demonstrated herein was PLA and the experiment was conducted at room temperature.

FIG. 5 displays the amount of washed out proppant as a function of NDF concentration.

FIG. 6 displays the amount of washed out proppant as a function of fluid linear velocity.

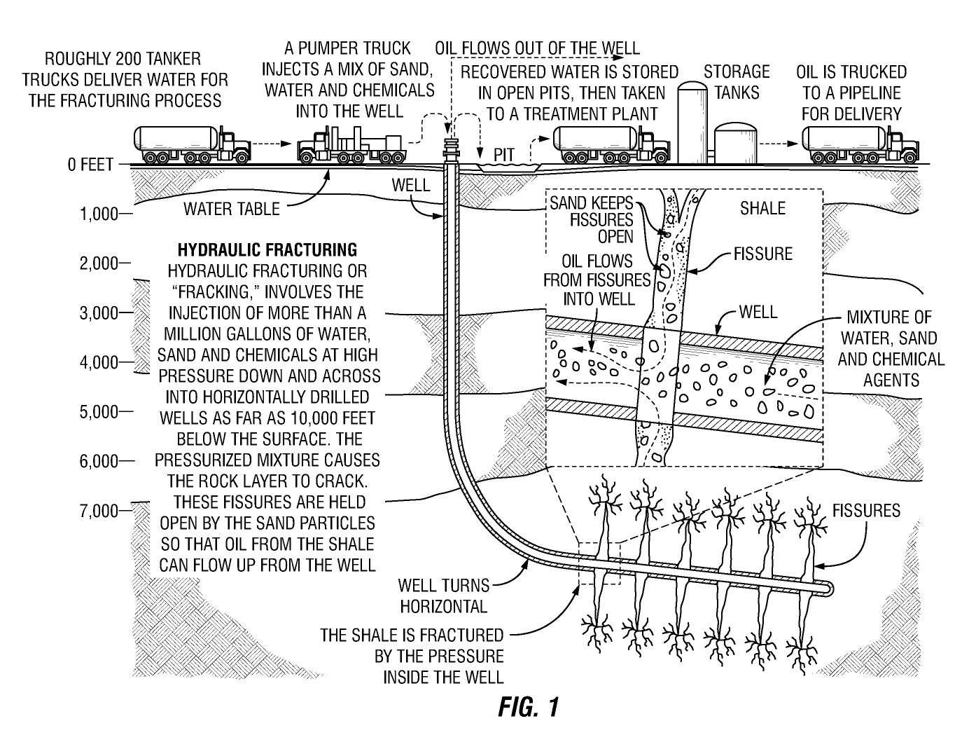

### DETAILED DESCRIPTION

Maintaining proppant pack integrity during the well life is important to long-term conductivity. The disclosure describes multiple apparatus, methods, and compositions to strengthen a proppant pack and extend its longevity. These can be used individually or combined in any combination and order as needed to facilitate proppant pillar placement, strength, stability, and resistance to washout. Additionally, these will also improve fracture conductivity. Fracture conductivity is the product of the fracture width and the permeability of the proppants. The permeability of all the commonly used propping agents (sand, RCS, and the ceramic proppants) will be 100 to 200+darcies when no stress has been applied to the propping agent. However, the conductivity of the fracture will be reduced during the life of the well because of the following.
Increasing stress on the propping agents
Stress corrosion affecting the proppant strength
Proppant crushing
Proppant embedment into the formation
Damage resulting from gel residue or fluid-loss additives
Proppant or pillar washout

It should be noted that in the development of any such actual embodiment, numerous decisions specific to circumstance must be made to achieve the developer's specific goals, such as compliance with reservoir-related or business-related constraints, which may vary from one implementation to another. Moreover, it will be appreciated that such a development effort might be complex and time-consuming but would nevertheless be a routine undertaking for those of ordinary skill in the art having the benefit of this disclosure.

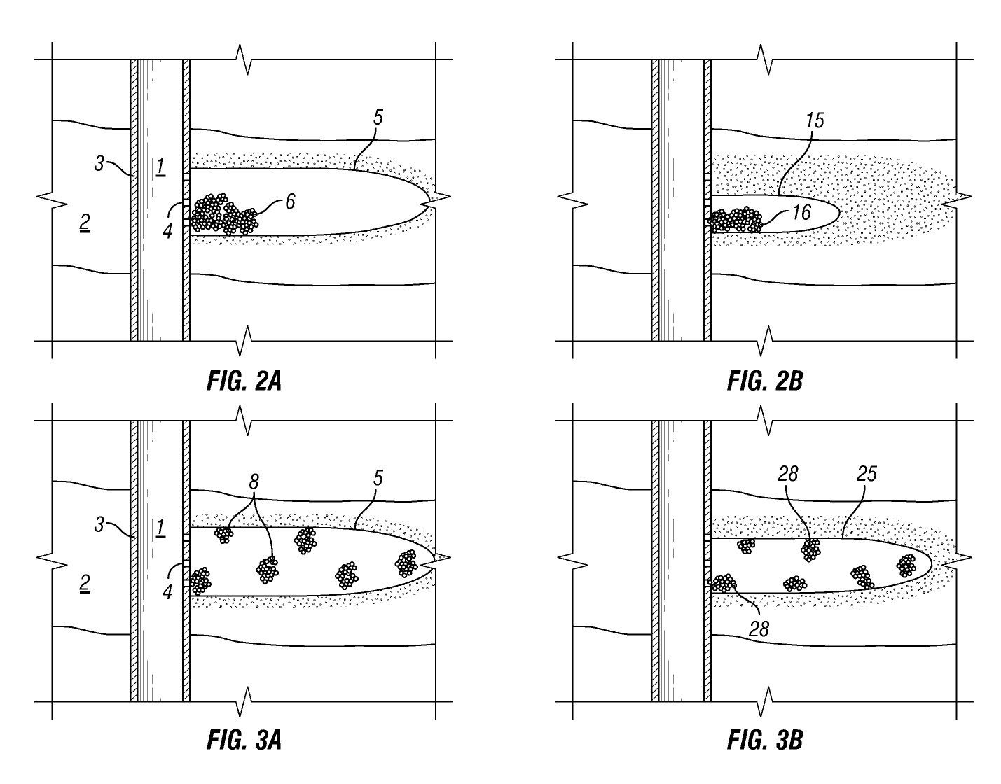

FIG. 2A is a schematic view of a fracture during the fracturing process using a homogenous proppant. A wellbore 1, drilling through a subterranean zone 2 that is expected to produce hydrocarbons, is cased and a cement sheath 3 is placed in the annulus between the casing and the wellbore walls. Perforations 4 are provided to establish a connection between the formation and the well. A fracturing fluid is pumped downhole at a rate and pressure sufficient to form a fracture 5 (side view). With such a waterfrac treatment, the homogenous proppant 6 tends to accumulate at the lower portion of the fracture near the perforations.

It is believed that the wedge of proppant happens because of the high settling rate in a poor proppant transport fluid and low fracture width as a result of the in-situ rock stresses and the low fluid viscosity. The proppant will settle on a low width point and accumulate with time. The hydraulic width (width of the fracture while pumping) will allow for considerable amounts to be accumulated prior to the end of the job. After the job is completed and pumping is ceased, the fracture will try and close as the pressure in the fracture decreases. The fracture will be held open by the accumulation of proppant as shown in the following FIG. 2A.

Once the pressure is released, as shown FIG. 2B, the fracture 15 shrinks both in length and height, slightly packing down the proppant 16 that remains in the same location near the perforations. The limitation in this treatment is that as the fracture closes after pumping, the “wedge of proppant” can only maintain an open (conductive) fracture for some distance above and laterally away. This distance depends on the formation properties (Young's Modulus, in-situ stress, etc.) and the properties of the proppant (type, size, concentration, etc.).

It is believed that the method of using a heterogeneous proppant pack, however, aids in redistribution of the proppant by affecting the wedge dynamically during the treatment. For this example, a low viscosity fluid is alternated with a low viscosity viscoelastic fluid, which has excellent proppant transport characteristics. The alternating stages of viscoelastic fluid will pick up, re-suspend, and transport some of the proppant wedge that has formed near the wellbore due to settling after the first stage. Due to the viscoelastic properties of the fluid the alternating stages pick up the proppant and form localized clusters (similar to the wedges) and redistribute them farther up and out into the hydraulic fracture.

This is illustrated in FIGS. 3A and 3B that again represents the fracture during pumping (FIG. 3A) and after pumping (FIG. 3B) and where the clusters 8 of proppant are spread out along a large fraction (if not all) of the fracture length. As a result, when the pressure is released, the clusters 28 remain spread along the whole fracture and minimize the shrinkage of the fracture 25.

Some embodiments alter low and high viscosity fluids for heterogeneous placement. A high viscosity and high proppant content fluid can be alternated with a high viscosity and low (including zero) proppant content fluid too.

Additives that are used in HPP treatment to form proppant pillars, which can be considered as slug dispersion preventing, cluster reinforcing, or cluster consolidating additives, are often degradable fibers (DF). However, degradable fibers are effective only during the flow-back stage of the treatment and during first period of well production (until fibers lose their reinforcing properties). The reinforcing effect disappears long before the fibers undergo complete degradation, typically at degradation of 20-30 weight percent of fibers.

This application discloses several approaches (which can be used separately or in any combination) of pillar reinforcing, which can be effective during flow-back, injection, and/or hydrocarbon production stage. In general, we describe herein two approaches to reinforce pillars-1) reduce forces acting on the proppant pack, or 2) increase pillars resistance to such forces. Below listed several approaches of proppant pack reinforcement.

### Reinforcing Additives for Pillar

There are two basic types of additives that can be added to pillars. The first are the additives that form a network of physical chains, interweaved into the proppant pack and thus reinforcing the proppants internally. The second approach is to add additives that fill the void space in the proppant pack, thus reinforcing pillars externally to the particulates.

Non-degradable fibers (NDF) are one of the examples of an additive that internally reinforce proppant pillars. Instead of degradable fibers that are conventionally used for HPP treatment, the NDF can reinforce proppant pack during the entire lifecycle of the well. This effect is reached by forming a permanent fiber network penetrating or wrapping the entire proppant pillar. Preferably, the NDF should be introduced during the propping stages of the treatment.

Non-degradable fibers include carbon, aramids, metal and glass fibers, as well as ceramic and mineral-based fibers and halloysite nanotubes. Cellulose based fibers are also non-degradable, such as nanocrystalline cellulose, nanofibrillated cellulose, cellulose microfibers, cellulose crystals, amorphous cellulose fibers. The fibers can be modified to add functional groups to enhance network formation or induce network/proppant interactions/bonding under downhole conditions.

Exemplary non-degradable fibers include: carbon fiber, or single and multiwall carbon nanotubes; aromatic polyamides (aramids) such as poly-paraphenylene terephthalamide (branded Twaron by Teij in Aramid and Kevlar® by DuPont), poly-meta-phenylene terephthalamide (brandname Nomex® by DuPont) and polyamide nylon; polyesters such as polyethylene terephthalate (PET) or polybutylene terephthalate (PBT); resins made from phenol-formaldehyde resins, polyvinyl chloride fiber, polyolefins (polyethylene and polypropylene) olefin fiber, acrylic polyesters, acrylic fiber, and polyurethane fiber; alumina fibers, silicon carbide fibers; and variants of asbestos.

Polymer particles have to have a reasonable size, e.g. >NLT 25, 50, 75 or 100 microns. Further, the polymer has to be insoluble in frac/production/injection fluid and resistant to frac chemistry (i.e. should not be broken, hydrolyzed etc.). The absorbency of the chosen polymer will depend on proppant pack composition and goals; however, an absorbent polymer is expected to benefit pillar stability.

An unexpected advantage to using non-degradable fibers is the enhanced transport of proppant particles irrespective of base fluid viscosity. By removing base fluid viscosity considerations, the proppant pack can easily be tailored to reservoir conditions to optimize fracture geometry. Furthermore, less polymer is required in the base fluid, which can increase permeability of hydrocarbons through the proppant pack, thus improving production.

The effect of NDF concentration on pack stability can be demonstrated by exposing proppant packs with different fiber concentration to fluid flow. We investigated three proppant packs containing PLA as an NDF at room temperature:

HSP 20/40+0 wt. % NDF

HSP 20/40+0.7 wt. % NDF

HSP 20/40+1.4 wt. % NDF.

The proppant packs were shaped like pillars and put under stress of 10-12 Kpsi.

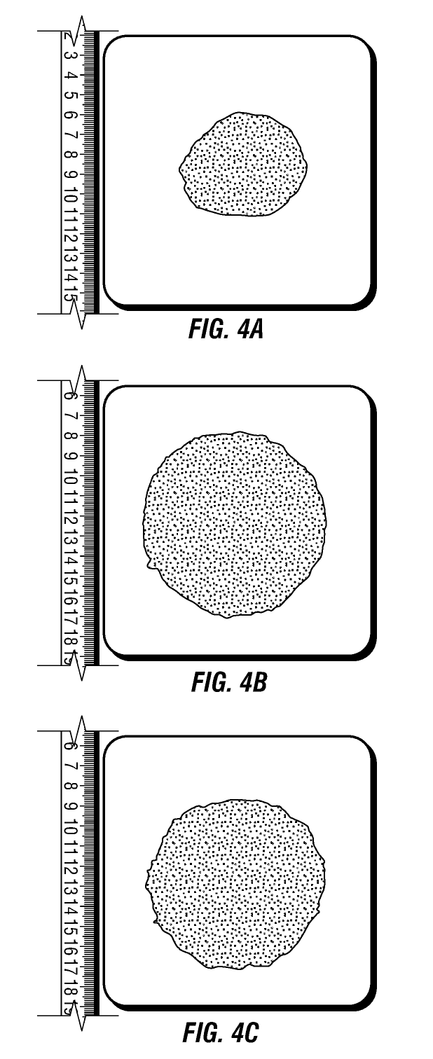

Thereafter, fluid flow was applied to the pack wherein the flow rate was adjusted to provide 0.5-1.0 m/s fluid linear velocity near the pack. FIG. 4A-C shows the proppant pack after exposure to the fluid flow for 2 hours, wherein 4A is 0 wt. % NDF, 4B is 0.7 wt. % NDF and 4C is 1.4 wt. % NDF.

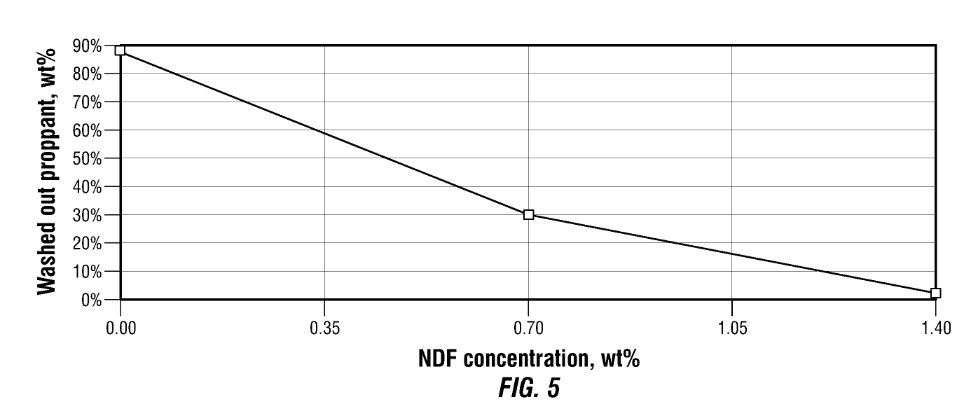

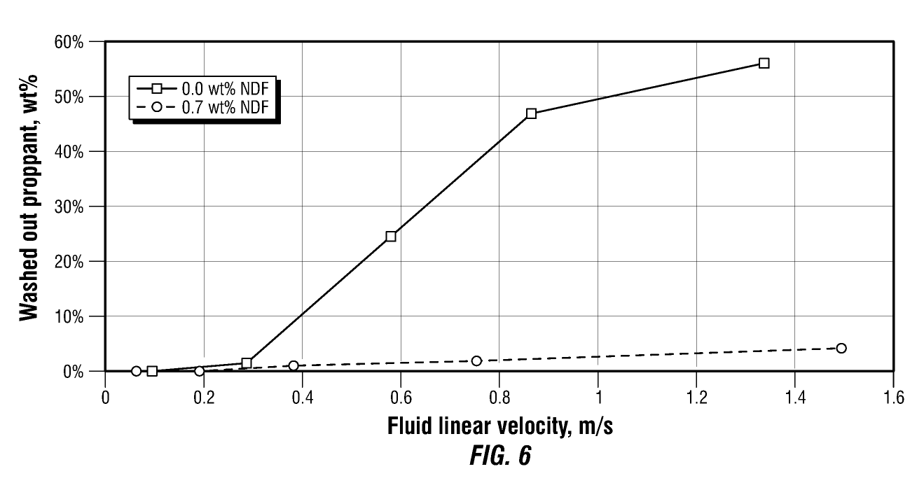

It is clearly seen in FIG. 4 that proppant pack stability under the fluid flow greatly increases with addition of NDF. FIG. 5 shows that the amount of proppant washed from the pack decreased as the concentration of NDF increased. FIG. 6 shows the dependency of pack stability (for pack with and without NDF is illustrated) versus fluid linear velocity.

It can be seen that NDF performance becomes considerable at certain fluid velocity, which in turn corresponds to production rate. Thus, pumping NDF should be considered for mid to high producing wells to enhance their performance.

The results on proppant pack stability obtained with NDF show the impact of stabilizing additives (when stabilization occurs due bonding proppant particles together and increasing particle-to-particle contact area) can influence for HPP treatment in scope of keeping channels open and preventing proppant flowback and sedimentation in the fracture.

Another example of pillar stabilizing agents are void space filling additives. Additives that fill void space in the proppant pack are usually softer than the proppant. These additives can be formed from either organic or inorganic materials or their combination. These can be formed from either crystalline or amorphous materials or their combination. For instance, such additives could contain synthetic polymers (polyethylene, polyurethane, and other elastomers, etc.), or natural organic materials including polymers or fibers (cotton, walnut shells, etc.), metal particles, or their combination.

Void filling additives can also be formed from soft inorganic materials found either in the nature such as minerals or rocks (chalk, carbonates, graphite, asbestos, etc.) or synthetized artificially or their combination. Such void filling additives can be delivered in the form of either particles, granulates, fibers, needles, crystals, or miniature pieces of sheets, aggregated/associated structures, or their combinations. These additives can be used as made or can be chemically/mechanically altered, and/or modified, and/or cleaned or refined to provide additional properties (e.g. increased affinity to proppant particles or formation rock surface, increased strength or softness or elastic properties, altered space fitting properties altered wettability etc.).

Porosity of the proppant pack is related, at least in part, to the interconnected interstitial spaces between the abutting proppant particulates. Such soft particles filling the voids between proppant grains will increase contact area between proppant particles and/or between these particles and formation rock and provide increased affinity of particles either to each other or to the formation rock—forming a strengthened pack structure sealed together by soft (or semi-soft) particles.

While the void space fillers are intended for voids inside the pillars (i.e. porosity inside the pack), they can be injected continuously because this may make the operation simpler. There will be a trade-off regarding the fluid flow, but the majority of the flow is in the channels where there should not be fibers permanently. Outside the pillars, the void space fillers can compromise conductivity and production. Also not all the void space in the pack is filled in the pillar, so some conductivity may be retained.

There are many more materials that can be used than those listed above. Guidelines for choosing an appropriate void space filler include:
a. Hardness less than that of proppant
b. Ability to crush under formation stress
c. Resistance to fluid and frac chemistry (i.e. does not hydrolyze or solvate in fluid)
d. At least 50 micron grain size (preferable about 50-75% or 80-100% of proppant grain size)

The void space fillers can also contain performance enhancers such as nano-fiber, nano-crystal, nano-plate additives, or combinations thereof. The concentration of these nano-additives is in the 0.01% wt to 20% by weight of the the void space filler.

### Modifying the Particles in the Pillar

Another approach to reinforcing proppant pack by increasing pillar resistance is to increase the interactions between the proppants themselves. The surface of the proppant particles can be modified to provide additional bonding between them. Requirements for such coating are a long-term ability to withstand the fluid flow and its reactivity (or layer ability to reheal itself/ regenerate under the production conditions) and a strong affinity to proppant grain surface.

Various methods that can be used to accomplish this include:

Chemical bonding: Proppant grains can be coated with material nonreactive at surface conditions but providing additional affinity to itself and/or proppant grains at bottom-hole conditions by chemical means. Another approach is to chemically treat the already placed proppant pack to increase affinity of proppant grains to each other.

The proppants can also be modified to reduce the chemical reactivity of proppant to materials encountered in the reservoir or well treatment, including but not limited to: oil, gas, water, brine, fracturing fluids, remedial acid treatments, caustic fluids commonly associated with steam or water injection, biological agents or their byproducts such as carbon dioxide and hydrogen sulfide. For instances, coatings that reduce the chemical reactions between proppants and surrounding fluids may reduce the formation of scale in situ on the proppant pack.

Mechanical bonding: Soft material layer deposited or precipitated on proppant grain can increase embedment of particles into each other thus increasing friction factor between the particles. Examples of such material can be resin (RCPs and RCSs), various inelastic polymers (e.g. polyethylene, polyurethane, polypropylene, soft plastics), precipitated alkali earth carbonates/sulfates etc. Curable resin coated proppants have been around since the 1980s. When cured, the coated proppants from a flexible lattice network that redistributes stress by reducing individual loads of the proppant particles. These materials can be used with any of the above improvements to form strong proppant pillars. However, redistribution of the proppant pack is difficult once the resin is cured.

Altering the wettability of particles: When particles of the proppant islands are wetted with a fluid, which is not fully miscible with the produced fluid, fluid bridges of the wetting fluid are formed between the proppant particles. These bridges provide attractive capillary forces between the particles. Hence, it is desirable to alter the wettability of the particles by the following fashion. When hydrocarbon fluid is produced, the proppant particles should be made hydrophilic; when aqueous liquid, or water vapor/steam is produced or injected the proppant particles should be made hydrophobic.

Grain surface architecture: The surface of proppant particles can be altered in several ways to increase the friction factor or cohesion between them:

Particle surface can be treated (either during manufacturing, before treatment or at later stages of the treatment) to increase the cohesive forces and/or, its roughness thus increasing friction factor between the particles. Examples of this approach include but not limited to: use of HSP proppant instead of LWP; using proppant with low roundness and sphericity, using proppant with etched surface etc. This can also be achieved by modifying particle in the following way: change proppant grain shape from sphere to streamlined body, thin disk aligned with the flow, dimpled “golf” ball etc.

Increased elasticity/plasticity of proppant particles: Proppant particles can be made of material (e.g. particles composed of polymer, metal or any material with sufficient Poisson's ratio), which changes its shape (becomes squashed) under bottom-hole conditions. Conventional proppant grains potentially can be treated the way to provide such properties. As a result proppant grains will have increased plastic/elastic properties comparing to original proppant. Such properties will provide enlarged contact between particles under applied stress. In addition particle shape will become closer to a thin disk. Both this factors contribute to the reinforcement of proppant pack.

Improving the particle interaction through surface modifications or coatings do not strengthen the individual particles themselves but rather improves the distribution of stress between the particles. This in turn will increase the strength of the proppant pack.

Methods of applying a coating for chemical or mechanical change include spraying, dipping, or soaking the proppant in the desired coating material, electroplating, plasma spraying, sputter, fluidizing, powder coating, or fusing material to the proppant. In some circumstances, the surface may need to be chemically etched to facilitate coating attachment.

The proppant particles can also have multiple layers with varying characteristics. In some embodiments, the outer layer would serve one particular purpose and would degrade under reservoir conditions such that the next layer would be exposed. For example, a proppant with an outer layer that increase lubrication between the proppant particles could be to facilitate more efficient proppant arrangement. Once packed, this outer coating can degrade to exposure the next coating with may have reactive chemical moieties that facilitate chemical binding between the proppant particles.

### Protective Coatings for Pillar

The proppant pack can be exposed (at later stages of treatment) to application of a material layer, which will reinforce the pack from the outside. Requirements for such layer include a long-term ability to withstand the fluid flow and its reactivity (or the ability of the layer to reheal itself under the production conditions), a strong affinity to proppant pack and an ability to coat the proppant pack without risk of reservoir impairment.

Reservoir impairment can be prevented for example as follows: (i) Coating can be placed at the time period when fracture is protected by filter cake; (ii) Proppant can be pretreated (most likely at surface) with layer(s), which provides additional affinity to the protective coating chemicals; (iii) Protective coating chemicals can be designed to provide additional affinity to proppant (by chemical means); (iv) Proppant can be designed to release coating chemicals under bottom-hole conditions; and, (v) Coating chemicals can be encapsulated and introduced to the proppant stages; these chemicals can be released under formation stress, reservoir conditions upon dissolution of the encapsulating material or can diffuse through encapsulating material.

Any pillar strengthening or coating material released at fracture closure or injected after proppant placement must have a strong affinity to the silica based surfaces. It should be a wetting phase if it is not miscible with the fracturing fluid, or it should adsorb strongly on silica based surfaces. Hence, there is an inherent danger of coating the overall fracture surface with these additives, which could be disastrous for the production. Therefore, filter cake deposited on the fracture surface can be beneficial because it would not allow the interaction of the rock surface with the coating. For instance, the channel surfaces would not be coated, because the filter cake could prevent the interaction. The filter cake could be formed during the very first period of fluid injection (the fluid could contain filter cake forming polymers for instance). However, these polymers are not necessarily present in the proppant containing slugs. Hence, the proppant is not coated with the polymer and the coating could only interact with the proppant in the pillars.

Coating material such as a thermoplastic material can be injected with the fracturing fluid. Such material may be encapsulated to delay the coating action. Under the appropriate conditions, the coating material may coat the proppant and pillars and the like. Ideally, the coating material is present in an amount from about 0.1 to 40 percent by weight of the proppant particulates, preferably 0.1 to 30 percent by weight and, most preferably, 0.1 to 20 percent by weight.

The alternatives of protective coating may be the following and are not limited to the following.

Rigid layer: A rigid layer referred to here and below is a layer that is substantially denser or more viscous than the fluid or having sufficiently high yield stress to resist fluid flow. This is a sealing layer impenetrable for fluid (completely protecting proppant pack from fluid exposure at least on the fluid-to-pack boundary). The rigid layer can be formed by in-situ crosslinking, or temperature activated hardening, or as a result of interaction of dual/multiple component additive, for instance dual component resins, self-curing resins, resins containing delayed curing agent, or when the curing agent is post injected.

Mechanically diverting layer: A type of layer (not necessary rigid) that has an ability to divert flow pattern from pack. This effect could, for example, be reached by special architectures of the layer surface (e.g. semi-rigid fibers partially embedded into the layer). Nylon or polypropylene fibers can be embedded into a proppant coating (resin, PE etc.). In turn, such particle can be coated with another coating (degradable, e.g. PLA) to protect fibers during pumping.

Chemically diverting layer: Another approach to divert a flow pattern from the pack is to enhance a protective coating (not necessary rigid) with e.g. hydrophilic properties (for reservoirs producing hydrophobic fluid).

Friction reducing layer: Layer (not necessary rigid) that has a friction factor between itself and the fluid less than one between proppant pack and the fluid.

Although only a few exemplary embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

The following are incorporated by reference herein in their entireties for all purposes.
U.S. Pat. No. 3,066,118, “Cross-linked carboxylic polymers of triallyl cyanurate and alkenoic acids.”
U.S. Pat. No. 3,426,004, “Crosslinked acrylic acid interpolymers.”
U.S. Pat. No. 3,951,926, “Cross-linked ethylene-maleic anhydride interpolymers.”
U.S. Pat. No. 6,776,235 “Hydraulic fracturing method.”
U.S. Pat. No. 8,061,424, U.S. Pat. No.8,584,755, US20090044945, US20120125618, “Methods for hydraulic fracturing of subterranean formation.”
U.S. Pat. No. 7,281,581 U.S. Pat. No. 7,325,608 “Methods of hydraulic fracturing and of propping fractures in subterranean formations.”
U.S. Pat. No. 7,044,220 “Compositions and methods for improving proppant pack permeability and fracture conductivity in a subterranean well”.
US20080135242 “Heterogeneous proppant placement in a fracture with removable channelant fill.”
US20120247764 “Proppant pillar placement in a fracture with high solid content fluid.”
US20080128131 “Methods for enhancing fracture conductivity in subterranean formations.”
SPE-149390-MS: Anup Viswanathan A., et al Completion Evaluation of the Eagle Ford Formation With Heterogeneous Proppant Placement (2011).
GYENES T, et al, Synthesis and swelling properties of novel pH-sensitive poly(aspartic acid) gels. Acta Biomater. 2008 4(3):733-44.
ARTURO HORTA, M. et al., The pH Inside a pH-Sensitive Gel Swollen in Aqueous Salt Solutions: Poly(N-vinylimidazole). Macromolecules 2009 42 (4), 1285-1292.
JIANG, H. L. and ZHU, K. J. Polyanion/gelatin complexes as pH-sensitive gels for controlled protein release. J. Appl. Polym. Sci., 2001 80: 1416-1425.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention, such as instructions for use, buffers, and the like.

The following abbreviations are used herein:

| ABBREVIATION | TERM |
|---|---|
| NDF | Non-degradable fiber |
| HPP | Heterogeneous proppant placement |
| HSP | High strength proppant |
| LWP | Light weight proppant |
| MSP | Medium strength proppant |
| RCS | Resin coated sand proppant |

1. A proppant slurry, the proppant slurry, comprising:
a base fluid;
a plurality of proppant particles for forming proppant pillars in a fracture of a reservoir; and
a plurality of non-degradable fibers.

2. The proppant slurry of claim 1, wherein the non-degradable fibers comprise carbon, cellulose, aramids, metal, mineral, glass fibers or combinations thereof.

3. The proppant slurry of claim 1, the proppant slurry including sand and light weight proppant and 0.1-5 percent non-degradable fibers.

4. The proppant slurry of claim 1, the proppant slurry including sand and 0.5-1.5 percent non-degradable fibers.

5. A method of fracturing a subterranean reservoir, comprising:
injecting a base fluid into a reservoir under sufficient pressure to fracture the reservoir;
co-injecting the base fluid plus proppant particles into the fracture;
injecting a pillar stabilizing additive into the fracture, wherein the injection can be a co-injection with the co-injecting or a separate injection; and
removing the base fluid to form a plurality of proppant pillars, wherein each proppant pillar comprising proppant particles and the pillar stabilizing additive, wherein the proppant pillar is 50 percent more stable to fluid flow with the pillar stabilizing additive as compared to a pillar without the pillar stabilizing additive.

6. The method of claim 5, wherein the pillar stabilizing additive is a void space filler for filling voids in the proppant pillars.

7. The method of claim 6, wherein the void space filler is a particle selected from a group consisting of a polymer, a semi-soft synthetic polymer, synthetic polymer having a hardness less than the proppant particles, a natural polymer immiscible with the base fluid, a metal, a mineral, a chalk, a carbonate, a graphite, an asbestos, or a combination thereof.

8. The method of claim 5, wherein the void space filler contains nano-fiber or nano-crystal, or nano-plate additives in a 0.1 to 20 percent by weight of void space filler.

9. The method of claim 5, wherein the pillar stabilizing additive is a non-degradable fiber.

10. The method of claim 8, wherein the non-degradable fiber is selected from the group consisting of carbon, cellulose, aramids, metal, mineral, or glass fibers, and combinations thereof.

11. The method of claim 5, wherein the pillar stabilizing additive is a thermoplastic material that coats the proppant pillar after the co-injecting or removing.

12. The method of claim 11, wherein the thermoplastic material is 0.1 to 20 percent by weight of the proppant.

13. The method of claim 5, wherein the pillar stabilizing additive is a coating material for coating the pillar.

14. The method of claim 13, wherein the coating material is encapsulated.

15. The method of claim 14, wherein the coating material is encapsulated by a heat-degrading material.

16. The method of claim 14, wherein the coating material is able to diffuse through the encapsulation.

17. The method of claim 13, wherein the coating material is more viscous than the base fluid.

18. The method of claim 13, wherein the coating has partially embedded semi-rigid fibers to divert flow around the proppant pillar.

19. The method of claim 13, wherein the coating is hydrophilic to divert flow around the proppant pillars.

20. The method of claim 13, wherein the coating has a lower friction factor than the base fluid and the proppant pack.

21. The method of claim 13, wherein the coating material is an adhesive coating material.

22. The method of claim 13, further comprising step injecting a second coating into the reservoir to further coat the proppant.

23. The method of claim 13, wherein the coating material is a soft material to increase friction between the proppant particles to mechanically bond the proppant particles via the soft material.
